(19) United States
(12) Patent Application Publication
(10) Pub. No.: US 2025/0356229 A1
(43) Pub. Date: Nov. 20, 2025

(54) METHOD FOR TRAINING A NEURAL NETWORK

(71) Applicant: Jean Michel SELLIER, Montreal (CA)

(72) Inventor: Jean Michel SELLIER, Montreal (CA)

(73) Assignee: TELEFONAKTIEBOLAGET LM ERICSSON (PUBL), Stockholm (SE)

(21) Appl. No.: 18/872,239

(22) PCT Filed: Jul. 4, 2022
(86) PCT No.: PCT/IB2022/056188

§ 371 Date: Dec. 5, 2024

(51) Int. Cl. G06N 10/20; G06N 3/0985; G06N 10/60

(52) U.S. Cl. CPC G06N 10/20; G06N 3/0985; G06N 10/60

(57) ABSTRACT

The disclosure relates to a computer implemented method, system, apparatus and non-transitory computer readable media for training an artificial neural network (ANN). The method comprises defining an energy function, for the ANN and a dataset, in terms of quantum objects and simulating a quantum system, using the quantum objects, to reduce the energy function and obtain a trained ANN. The method may further comprise using the reduced energy function as an input to a genetic algorithm for refining the reduced energy function.

### TECHNICAL FIELD

The present disclosure relates to a quantum inspired method for training a neural network.

### BACKGROUND

The fifth generation (5G) of wireless networks is expected to lay a foundation of intelligent networks with the provision of some isolated artificial intelligence (AI) operations. It is envisaged, though, that networks beyond 5G will benefit from fully intelligent orchestration and management to ensure a manifold increase in the network performance and service types. The increasingly stringent performance requirements of these emerging networks are expected to be provided by new technologies among which quantum machine learning (QML) is considered a core sixth generation (6G) enabler. Herein, by QML one broadly means the interplay of two disciplines, machine learning (ML) and quantum mechanics, to achieve any sort of computational advantages, e.g., algorithm speedup, lower memory consumption, better quality of solutions, etc.

Although it is still relatively unknown, QML is a discipline which exists since around three decades, but it is only now that this field is truly emerging (its growth has been hindered mainly because of the intrinsic complexity of the field itself, both in terms of hardware and software but certainly not because of a lack of interest).

In telecommunications, two specific factors are pushing towards the adoption of QML. On one hand, it is presumed that 6G networks will massively use the data coming from the network itself and harness it to obtain intelligent and autonomous networks. On the other hand, though, Moore's law has now reached a plateau and computational hardware is not significantly improving anymore. Consequently, this is motivating a growing number of practitioners to explore alternatives, among which the possibility of harnessing the power of quantum computation to provide advantages to ML algorithms. Furthermore, it also has recently become clear that current technologies and techniques in ML models, such as neural networks, are starting to reach their limitations and novel learning approaches are now necessary.

### SUMMARY

There is provided a computer implemented method for training an artificial neural network (ANN). The method comprises defining an energy function, for the ANN and a dataset, in terms of quantum objects and simulating a quantum system, using the quantum objects, to reduce the energy function and obtain a trained ANN.

There is provided a system for training an artificial neural network (ANN). The system comprises processing circuitry and a memory. The memory contains instructions executable by the processing circuitry whereby the system is operative to define an energy function, for the ANN and a dataset, in terms of quantum objects and simulate a quantum system, using the quantum objects, to reduce the energy function and obtain a trained ANN.

There is provided a non-transitory computer readable media having stored thereon instructions for training an artificial neural network (ANN). The instructions comprise defining an energy function, for the ANN and a dataset, in terms of quantum objects and simulating a quantum system, using the quantum objects, to reduce the energy function and obtain a trained ANN.

The method, system and non-transitory computer readable media provided herein present a new paradigm for training an artificial neural network (ANN) and provide improvements to the field of ANN training.

### BRIEF DESCRIPTION OF THE DRAWINGS

FIG. 1 is a schematic illustration of an artificial neural network.

FIG. 2 is a schematic illustration of an artificial neuron.

FIG. 3 is a schematic illustration of a multi-dimensional energetic valley represented by an error function.

FIG. 4a is a flowchart of a method for training an artificial neural network (ANN).

FIG. 4b is an example pseudocode defining an artificial neural network (ANN).

FIGS. 5 and 6 are plots of the error/cost/loss function, in linear (FIG. 5) and logarithmic (FIG. 6) scales, obtained by training an ANN by means of the gradient descent method, in the context of a quadratic function test.

FIGS. 7 and 8 are plots of the error/cost/loss function, in linear (FIG. 7) and logarithmic (figure8) scale, obtained by training the ANN by means of the method proposed herein, in the context of the quadratic function test.

FIGS. 9 and 10 are plots of the value of the hyper-parameters of the network in function of the iteration number (arbitrary units) for the gradient descent method (FIG. 9) and for the method proposed herein (FIG. 10), in the context of the quadratic function test.

FIG. 11 shows the quadratic function to be fit, represented by the line with dots, the curve found by the method proposed herein, represented by the line with crosses, and the curve found by the gradient descent method, represented by the line with diamonds, in the context of the quadratic function test.

FIGS. 12 and 13 are plots of the error/cost/loss function, in linear (FIG. 12) and logarithmic (FIG. 13) scale, obtained by training the ANN by means of the gradient descent method, in the context of a square root function test.

FIGS. 14 and 15 are plots of the error/cost/loss function, in linear (FIG. 14) and logarithmic (FIG. 15) scale, obtained by training the ANN by means of the method proposed herein, in the context of the square root function test.

FIGS. 16 and 17 are plots of the value of the hyper-parameters of the network in function of the iteration number (arbitrary units) for the gradient descent method (FIG. 16) and for the method proposed herein (FIG. 17), in the context of the square root function test.

FIG. 18 shows the square root function to be fit, represented by the line with dots, the curve found by the method proposed herein, represented by the line with crosses, and the curve found by the gradient descent method, represented by the line with diamonds, in the context of the square root function test.

FIG. 19 is a flowchart of a method for training an artificial neural network (ANN).

FIG. 20 is a schematic illustration of a hardware in which steps and/or method described herein can be executed.

FIG. 21 is a schematic illustration of a virtualization environment in which the different method(s) and apparatus(es) described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

While still in its infancy, quantum machine learning (QML) has the potential to provide practical and novel solutions in several fields of Science and Technology. Quantum mechanical systems are well known to generate counterintuitive patterns in data. On the other hand, classical machine learning (ML) models frequently have the feature that they can both recognize statistical patterns in data and produce data that possess the same statistical patterns. In other words, neural networks recognize the patterns that they produce. Consequently, the above observations suggest that quantum effects could be exploited to create a new kind of artificial neural networks which could recognize patterns that are very difficult to recognize classically. This will enable QML to play a very important role in the future development of telecommunication networks.

Very broadly speaking, the field of QML can be seen as the combination of ML, quantum mechanics and certain aspects of quantum computing. Although a clear and generally accepted definition for QML is not provided yet, it seems that the vast majority of the community is moving in the direction represented by using actual quantum computing hardware to obtain advantages such as quantum speedup and/or reduction of memory consumption in ML algorithms. The problem with this approach, though, is that quantum computing technologies are not expected to be at reach any time soon, and for good reasons. If quantum effects must be exploited in some way, a different approach is going to be needed (at least at this present stage).

Some QML algorithms proposed in the literature are based on the use of typical quantum effects such as entanglement, coherent transport, tunnelling effects, etc. It is very well known that such physical systems are extremely difficult to maintain in the real world. In fact, these systems require specific cryogenic facilities to maintain the temperature to the absolute zero (i.e., −273.16 Celsius degrees). Moreover, even in the presence of such temperatures, it is known that decoherence eventually enters into play and destroys the “quantumness” of the system, rendering it to a classical one (therefore losing any eventual quantum advantage). If one wants to concretely utilize quantum states to, say, train neural networks, most certainly a different and new approach must be provided.

The goal of the solution proposed herein is the training of neural networks i.e. a novel learning algorithm with a special focus on artificial neural networks (the very same method could be applied, though, to different predictive models as well).

The solution presented in this work is effective and does not exploit any physical quantum systems; on the contrary it is based on the use of digital computers which are commercially available, therefore providing a very different paradigm. In practice, provided an artificial neural network (ANN) to train on a given dataset, it is always possible to design and simulate a corresponding physical system which can perform the training process by reaching its point of minimum energy by simple evolution in time; in other words the point of minimum energy reached by the system after some time represents the solution which provides the final weights and biases of the ANN (it is well-known in Physics that physical systems always evolve in a way that reduces their internal energy).

The present disclosure proposes to simulate the behaviour of a quantum system. To make the simulations fast, while still reliable for the purpose of training ANNs, an approximation is introduced, based on the density functional theory (DFT) which is known among computational chemists. This represents a practical and realistic way to obtain the quantum state corresponding to the minimum energy of the system. Therefore, it will be shown that this approach is capable of training ML models in a way that is unprecedented. This, in turn, opens the way towards practical QML without the need of using an actual quantum computing device (simulated and measured quantum states are expected to be the same or very similar).

It should be noted that the tool/system described herein does not represent a quantum optimizer, a quantum annealer or anything of that sort. Additionally, the aim of this work is not to obtain any quantum advantage in terms of execution speed or memory usage but, instead, it is to introduce a novel learning method, based on a simplified simulation of physical quantum systems, to train neural networks in a very different quantitative and qualitative way. Consequently, this approach can obtain qualitatively different neural models (compared with traditional machine learning methods) without having to recur to any actual quantum physical system.

There are three main innovations introduced herein which are discussed in the paragraphs below.

It is well known that quantum solvers provide patterns which are difficult (or even impossible) to obtain by means of classical approaches. So far, these states are obtained by means of experimental measurements of actual physical systems which are affected by a plethora of different issues (e.g., decoherence). The goal of the system/technology presented herein is to provide a practical and realistic way to obtain those quantum patterns. In practice, the suggested approach introduces a way to exploit approximated digital simulations to obtain quantum states which can be, in turn, utilized to train ANNs so to obtain qualitatively different models. This represents an important departure from the currently explored paradigms in QML.

The way the (many-body) quantum system is digitally simulated is based on a novel suggested approximation which is inspired by the density functional theory (DFT) coming from computational chemistry. In the context of QML, this is the first time that such approximations are introduced in DFT simulations to achieve an actual and practical aspect of QML (i.e., the training of ANNs).

A different behavior of ANNs is observed when trained by means of the method proposed herein, which cannot be mimicked by classical ML training methods such as, e.g., the gradient descent method. This comes from the fact that quantum tunnelling effects are exploited during the training phase which, consequently, enables to find relevant quantum states relatively quickly. This represents a very different and novel paradigm to train ANNs.

The approach presented herein introduces important advantages in practical applications.

While its aim is to find quantum states to train neural networks, this method is not based on the use of any physical quantum systems which are known to be expensive and difficult to maintain (for instance, because of the increase of decoherence in the system due to the temperature and intrinsic external noise). Therefore, the proposed approach is not affected by any of the serious issues faced by the community of QML planning to exploit actual physical systems.

The quantum states necessary to train a given neural network are computed by running a simplified, yet still accurate, simulation of a many-body quantum system on digital computers. This allows anyone to use commercially accessible (i.e., relatively cheap) computers to train ANNs more efficiently and in a different way, therefore enabling different behaviors of the networks.

This approach, although simulated on a digital computer, exploits a quintessential quantum effect, i.e., the tunnelling effect. This is of great importance since it is well known that current (classical) learning methods, for instance gradient descent, can rapidly get stuck into energetic valleys of the cost/objective/loss function which, in turn, restricts the training of an ANN to a local minimum, and not to the optimal solution. This issue is avoided by the proposed approach.

Because it effectively exploits quantum tunnelling, one can also expect that certain neural networks which are difficult to train with the current learning methods could be trained with success by the approach proposed here (e.g., recurrent ANNs).

Finally, this method enables real-life QML capabilities right away, while other communities are still waiting for the (future) development of quantum computing devices. A technology such as the one described herein may become important for some aspect of future telecommunication applications (from 5G and beyond).

ANN training as an optimization problem.

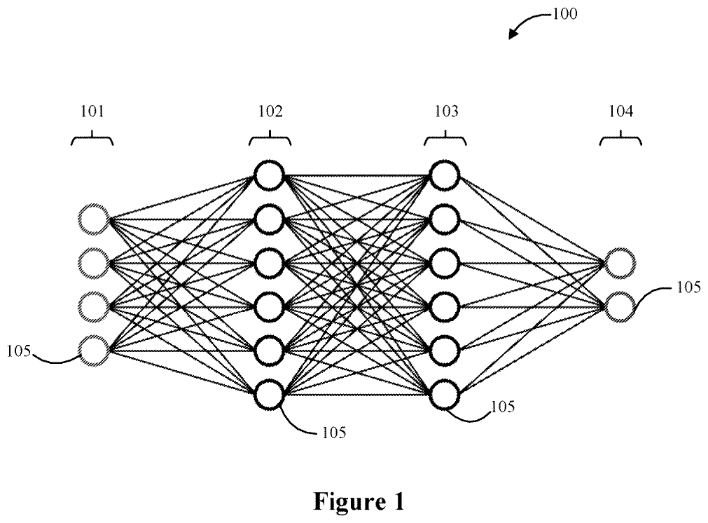

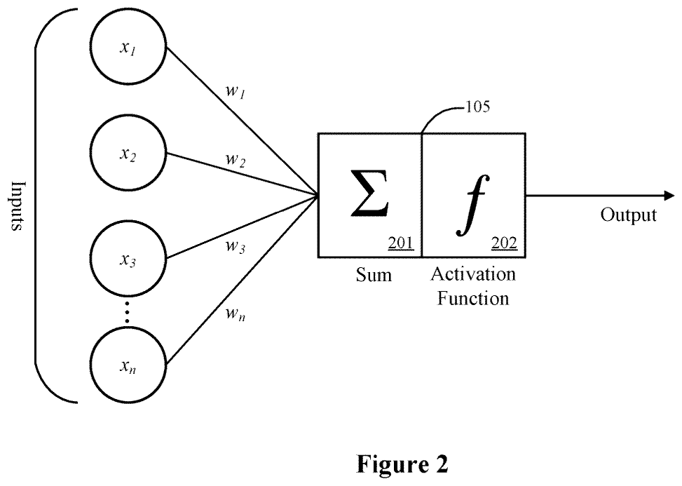

A neural network, or ANN, is a mathematical abstraction of biological neural networks and can be considered as a collection of connected computing units, or artificial neurons, which connection strength is represented by a number known as the weight. Consequently, the more connections a network has, the more weights are necessary. Referring to FIG. 1, in this context, feedforward ANNs 100 can be seen as constituted of layers 101 to 104 of neurons 105 which transfer information from one layer to the next one, i.e., from an input layer 101 towards an output layer 104 through one or more hidden layers 102 and 103. FIG. 2 illustrates an individual artificial neuron 105.

Referring to FIG. 2, every neuron 105 in an ANN 100 is characterized by a discriminant function 201 and an activation function 202 which acts on the discriminant. In more details, if a neuron has a set of inputs x=(x₁, x₂, . . . , xₙ) and a set of weights w=(w₁, w₂, . . . , wₙ), a common choice for the discriminant function is the quantity

$$z = {\sum }_{i = 1}^{n} {w}_{i} {x}_{i} .$$

For simplicity, the bias of a neuron is embedded in the sum by enforcing the condition x₁=1. There are plenty of possible choices for the activation function, usually indicated as a general (non-linear) function σ-σ(z). A person skilled in the art would know activation functions and be able to select an activation function according to a given set of circumstances.

Once the topology/architecture of a network 100 is defined (i.e., the number of layers, the number of neurons per layer and their connections, along with the discriminant and activation functions for each neuron), it is possible to mathematically express any ANN as a function of the type below:

$$y = y ( x ; w )$$

with x representing the input, w the set of all weights and y being an output value computed by the network (the variables x and y can be scalars or vectors depending on the use case, herein, vectors are denoted in bold style and scalars in italic style respectively). A person skilled in the art would know the type of ANN to select and how to define the topology of the ANN according to a given set of circumstances.

Thus, provided some sample set (xⁱ; yⁱ), for i=1, . . . , Nₛ, (usually referred to as the dataset) describing the computational goal to be achieved by the network, the problem of training an ANN consists of minimizing some error function, also known as the loss, the objective, or the cost function, which formally reads:

$$E = E ( y ( x ; w ) , ( {x}^{i} , {y}^{i} ) ) ,$$

and which depends on the whole set of weights. In practice, this goal is accomplished by looking for the set w* which minimizes the error function E=E(w). Many different algorithms exist to reach this goal, one of the most popular being the well-known gradient descent method, represented by the combination of the gradient descent and backpropagation methods. For instance, the error function can be represented by an L₂ norm of some shape. A person skilled in the art would know error functions and be able to select an error function according to a given set of circumstances.

For the sake of clarity and completeness, the main tenets of the gradient descent approach to train ANNs is introduced next.

One of the simplest training algorithms is the gradient descent method, sometimes also known as steepest descent method. In the batch version of the gradient descent approach, the initial weight vector is often random, and is denoted by w⁽⁰⁾. Then, the weights are iteratively updated such that, at the n-th step, they move a short distance in the direction of the greatest rate of decrease of the error, i.e., in the direction of the negative gradient, evaluated at w⁽ⁿ⁾:

$${w}^{( n )} = {w}^{( n - 1 )} - η ∇ E ( {w}^{( n - 1 )} ) . \qquad ( 1 )$$

The gradient is re-evaluated at each step. In the sequential version of gradient descent, the error function gradient is evaluated for just one pattern at a time in a similar way. In equation (1), the parameter η is called the learning rate, and provided its value is sufficiently small, the value of E should decrease at each successive step, eventually leading to a weight vector at which ∇E=0 is satisfied.

One of the limitations of the gradient descent technique is the need to choose a suitable value for the learning rate parameter η. The problems with this method do not stop there, however. For instance, in the case of a multi-dimensional weight space, the curvature of E can vary significantly with direction. At most points on the error surface, the local gradient does not point towards the minimum. Gradient descent then takes many small steps to reach the minimum and is clearly a very inefficient procedure. The method presented herein avoids this sort of issue.

A physical interpretation of the gradient descent technique and its quantum counterpart can now be introduced which will, in turn, help to understand the approach presented herein.

The updating rule (1), provided above, is reminiscent of classical physics. As a matter of fact, there is a strong similarity with the very well-known Newton's formulation mathematically expressed as:

$$ma = F$$

where m is the mass of a particle with acceleration a, and in the presence of an applied force F which can written as the gradient of a potential U=U(x), i.e., F=−∇ₓU, with x being the position.

In more details, by using the fact that a is the second derivative of the position x, exploiting the finite difference approach for derivatives, and by integrating the formula with respect to time in the range [t₀, t], one finally gets:

$$x = {x}_{0} - λ ∇ U ( {x}_{0} ) , \qquad ( 2 )$$

with λ=1/m (t−t₀)² (the approximation

$$m v = - {\int }_{{t}_{0}}^{t} ∇ U ( x ) d x ≅ - ∇ U ( x ) ( t - {t}_{0} ) = - ∇ U ( x ) Δ t$$

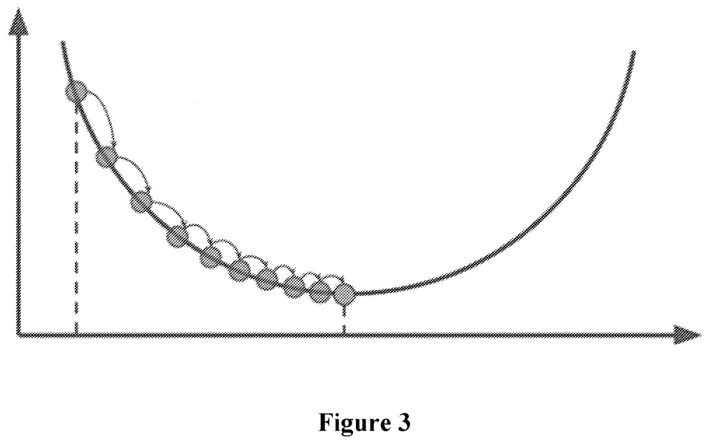

has been introduced, which is a valid assumption for small temporal ranges). Clearly, formula (2) has the same mathematical shape of formula (1) used to update the weights (and biases) of a neural network. Thus, in a broad sense, one might interpret the gradient descent method as a physical system which evolves in time and, consequently, reduces its internal energy. For instance, it could be interpretated as a “multi-dimensional ball” falling in a multi-dimensional energetic valley represented by the error function, or as a set of N one-dimensional balls each falling in a one-dimensional energetic valley (see FIG. 3), i.e., the same number as the number of weights to be trained in the ANN.

Converting this classical system into a corresponding quantum one is a matter of replacing the above time-dependent classical equation (2) by its corresponding Schrödinger equation while keeping the same applied potential energy U=U(x). One obtains:

$$i ℏ \frac{\partial Ψ}{\partial t} = \hat{H} Ψ = ( - \frac{{ℏ}^{2} {∇}^{2}}{2 m} + U ( x ) ) Ψ , \qquad ( 3 )$$

with ℏ the reduced Planck constant and Ĥ the Hamiltonian of the system, which is equal to the sum of the kinetic operator and the applied potential. Therefore, instead of approaching this problem by means of the gradient descent method, which in this context roughly corresponds to the simulation of a classical many-body system, the problem also can alternatively be solved by means of simulations of corresponding quantum many-body systems. This eventually enables the presence of quantum tunnelling in such simulations, something that will never be present in a classical context. In turn, tunnelling can (and does) enable a better search of the solution since it is not affected by the typical issues that affect the gradient descent method (e.g., the search for solutions will not get stuck locally in a potential valley representing some non-optimal local minimum).

Therefore, for any given ANN with N hyper-parameters to be trained, there will be N corresponding Schrödinger equations to be simulated, just like there are N updating equations in the gradient descent method. Further below, there will be a description of the way these Schrödinger equations are concretely coupled.

In the next section, the discretization scheme used in this document to numerically solve the Schrödinger equation, the finite-difference time dependent method, is presented.

The Schrödinger equation described above cannot be treated analytically due to the very complicated shape of the applied potential (which, in this particular case, is represented by the error function corresponding to the given ANN and dataset). Thus, one must recur to numerical methods to extract its time-dependent solution (i.e., the wave function Ψ=Ψ(x, t)). Many methods are nowadays available, and, for the sake of a complete validation process, the well-known finite-difference time domain (FDTD) method was selected because of its relative simplicity and accuracy. Of course, this choice does not represent a limitation of the method presented in this paper disclosure since other methods could be utilized equivalently, as would be apparent to a person skilled in the art.

The FDTD method has started as a discretized algorithm in the field of computational electrodynamics, but it has recently found use in the simulation of quantum mechanical systems as well. In classical FDTD, Maxwell's equations are discretized on a grid and solved explicitly using leap-frog integration in time. Since the FDTD algorithm is explicit and local, it can be implemented and parallelized. In turn, applying FDTD to solve the Schrödinger equation yields a method that can be implemented and is computationally efficient. Although, nonuniform grids have been utilized for the electrodynamics FDTD method and could be used for the Schrödinger equation, these are not used herein for the sake of keeping this description as simple as possible, but could be used in certain embodiments.

Below are described the main tenets of the FDTD method applied to the Schrödinger equation. First, the complex valued wavefunction is split into real and imaginary components:

$$Ψ ( x , t ) = {Ψ}_{R} ( x , t ) + i {Ψ}_{I} ( x , t ) ,$$

with Ψ_{R} and Ψ_{I} the real and imaginary parts of the wave function, respectively. The Schrödinger equation then becomes (in a one-dimensional space):

$$\begin{matrix}\frac{\partial {Ψ}_{R}}{\partial t} = - \frac{1}{2 m} {ℏ}^{2} {∇}^{2} {Ψ}_{I} + V ( x ) {Ψ}_{I} , \\ \frac{\partial {Ψ}_{I}}{\partial t} = - \frac{1}{2 m} {ℏ}^{2} {∇}^{2} {Ψ}_{R} - V ( x ) {Ψ}_{R} .\end{matrix}$$

Then, the time derivatives are approximated using central finite differences, as per the FDTD method, providing the (finite difference) evolution equations. Evolution equations are the equations which describe the time-dependent evolution of a physical system. For example, a ball falling in the gravitational field would be described by the Newton equations, while a black hole would be described by Einstein's equation, etc. Due to the explicit discretization of the time derivative, there is an upper bound for the time step to ensure stability, which depends on both the grid cell size and the maximum absolute value of the potential within the computational domain. Finally, this evolution method can be used to solve general time-dependent problems, including a time-dependent potential.

This is a very robust and accurate method. As a matter of fact, it has been utilized to compute very sophisticated quantities such as the spectrum of atoms and their wave-functions.

Having introduced the tools and ideas needed to understand the method proposed herein, the description of the method itself is provided below. Below, this method will be referred to as the quantum inspired method.

Training ANNs by means of simulations of quantum systems.

It was previously discussed that the problem of training an ANN essentially consists of minimizing a corresponding error function, which reads E=E(y(x; w); (xⁱ, yⁱ)), and where (xⁱ,yⁱ), for i=1 . . . Nₛ, is known as the dataset. In this context, if the ANN has N hyper-parameters, then N corresponding evolution equations must be solved, such as formula (1) previously introduced for the gradient descent method. Although this might represent a strong departure from classical methods, it becomes immediately clear that it is possible to replace formulas (1) with a set of N corresponding Schrödinger equations (3)—this is the first main difference between the proposed quantum inspired method and the well-known standard classical ones. These equations, in turn, can be solved numerically by means of the FDTD method described above.

In practice, this set of N equations is going to read:

$$\begin{matrix}i ℏ \frac{\partial {Ψ}_{1}}{\partial t} = ( - \frac{{ℏ}^{2}}{2 m} \frac{{\partial }^{2}}{\partial {x}_{1}^{2}} + U ( {x}_{1} , {x}_{2} , … , {x}_{N} ) ) {Ψ}_{1} , \\ i ℏ \frac{\partial {Ψ}_{2}}{\partial t} = ( - \frac{{ℏ}^{2}}{2 m} \frac{{\partial }^{2}}{\partial {x}_{2}^{2}} + U ( {x}_{1} , {x}_{2} , … , {x}_{N} ) ) {Ψ}_{2} , \\ … \\ i ℏ \frac{\partial {Ψ}_{N}}{\partial t} = ( - \frac{{ℏ}^{2}}{2 m} \frac{{\partial }^{2}}{\partial {x}_{N}^{2}} + U ( {x}_{1} , {x}_{2} , … , {x}_{N} ) ) {Ψ}_{N}\end{matrix}$$

where U=U(x)=U(x₁, x₂, . . . , x_{N}).

The system described by the equations above represents an ensemble of N quantum objects, for example electrons, interacting with each other through a given potential which is represented by the error function U=U(x₁, x₂, . . . , x_{N}) (to be precise the potential U should be multiplied by the elementary charge constant q).

The precise shape of the coupling between the equations still has to be specified though. A concrete way to obtain this coupling is provided by approximating, or in other words tailoring, well-known techniques coming from DFT for the problem at hand—this is the second main difference between the proposed quantum inspired method and classical DFT approaches. In practice, it starts from the main problem tackled in DFT, which is represented by the simulation of the many-body Schrödinger equation which reads:

$$i ℏ \frac{\partial Ψ ( {x}_{1} , {x}_{2} , … , {x}_{N} )}{\partial t} = ( - \frac{{ℏ}^{2}}{2 m} {\sum }_{j = 1}^{N} \frac{{\partial }^{2}}{\partial {x}_{j}^{2}} + U ( {x}_{1} , {x}_{2} , … , {x}_{N} ) ) Ψ ( {x}_{1} , {x}_{2} , … , {x}_{N} ) , \qquad ( 4 )$$

where now the wave-function is a function depending on the variables (x₁, x₂, . . . , x_{N}). Of course, this is a daunting problem even when approached by numerical techniques. In DFT, these are typical difficulties which are solved by introducing the so-called Kohn-Sham system which consists of a system of N single-body equations which are coupled by introducing an exchange-correlation potential. The exact mathematical shape of this potential is usually unknown, and many different approximations have been proposed (with pros and cons). Herein, a new coupling potential is proposed in the spirit of DFT but with a different goal which is to efficiently obtain the quantum states which correspond to the minimization of the error function (the energy of the system in this case) or, equivalently, to the training of ANNs (in other words, the accuracy of this method is focusing on training an ANN, not on computing quantum chemical features).

In the Kohn-Sham system of equations, the coupling usually has the following mathematical shape (for the i-th body described by a single-body Schrödinger equation):

$$V ( {x}_{i} ) = {V}_{ext} ( {x}_{i} ) + {V}_{x c} [ ρ ( x ) ] ( {x}_{i} ) ,$$

where the main message to retain is the fact that an exchange-correlation potential is introduced which depends only on one (electron) variable at a time, therefore completely avoiding the problem of simulating the many-body Schrödinger equation (4). In computational chemistry, this exchange-correlation potential can be any function possible as long as it represents the system at hand up to a desired certain level of realism (depending on the problem at hand).

Herein, the following potential is introduced, to be utilized for the specific purpose of training ANNs:

$$U ( {x}_{i} ) = U ( {\overline{x}}_{1} , {\overline{x}}_{2} , … , {\overline{x}}_{i - 1} , {x}_{i} , {\overline{x}}_{i + 1} , … , {\overline{x}}_{N} ) ,$$

where the symbols x̅ᵢ, for i=1, . . . , N, mean the average position of the i-th body according to its wave-function, i.e., in mathematical terms:

$${\overline{x}}_{i} = {\int }_{0}^{{L}_{x}} x {\vert {Ψ}_{i} ( x ) \vert}^{2} d x$$

with Lₓ being the length of the (one-dimensional) spatial domain. This potential would not be of any use if it were to be applied to the simulation of an actual physical (quantum) system—this is completely acceptable since this is not the purpose of this work (it also might happen that more realistic potentials provide some advantages, but this is not the scope of this work). The proposed potential introduces advantages in terms of finding the right quantum states corresponding to a properly trained ANN. As a matter of fact, it is a potential which becomes zero if, and only if, each of the N wave functions of the system have an average position x̅ᵢ corresponding to the solutions of the problem at hand, i.e., U(x̅₁̅, x̅₂̅, . . . , x̅_̅{̅N̅}̅)=0.

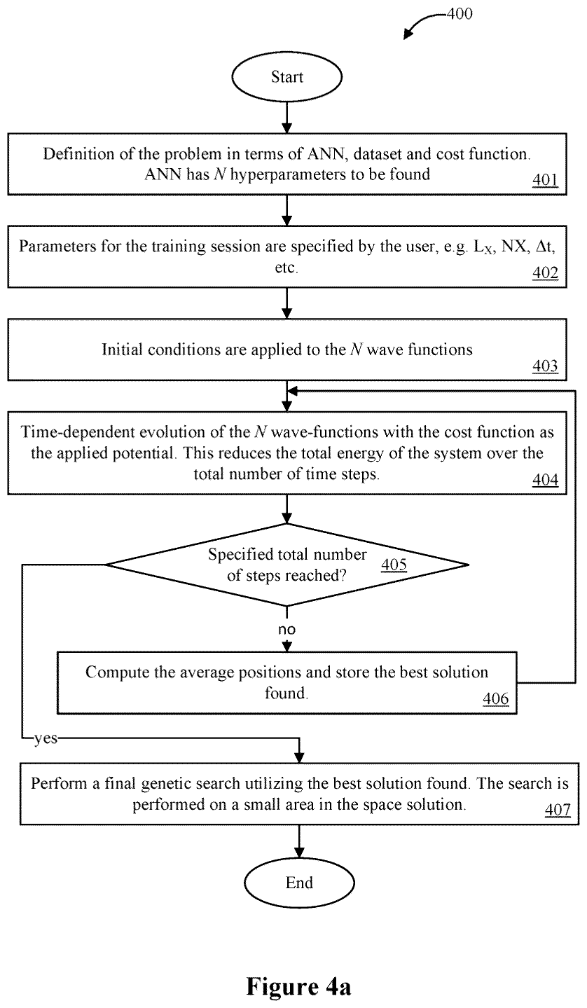

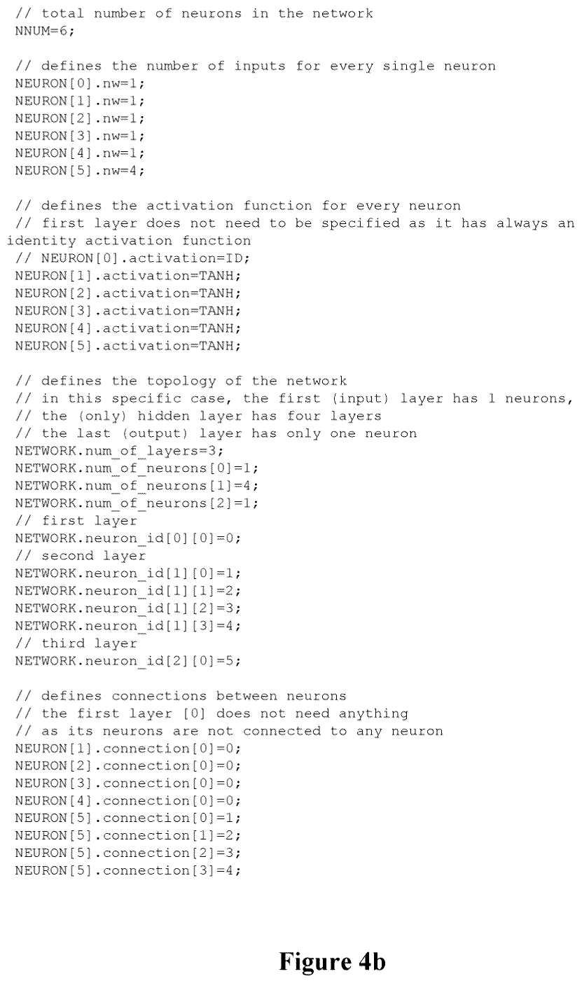

FIG. 4a illustrates the steps of a method 400 to perform the training of a given ANN within the context of the tools presented so far; for every step, comments are added for the sake of clarity and completeness.

An artificial neural network is specified along with a dataset and its corresponding error function, step 401. More specifically, the network is provided by specifying its neurons, layers, connections, etc. (see the pseudocode of FIG. 4b), while the dataset is provided as a set of input-output correlations (e.g., data and labels). The network is provided with N hyper-parameters to be computed to reduce the error (or, equivalently, the energy of the system). These N hyper-parameters are represented by the N average positions of the N wave functions described in the steps below.

A one-dimensional spatial domain is specified by the user, step 402, by means of its length Lₓ. Other physics related hyper-parameters are defined as well, more specifically the number of spatial cells NX, a time step Δt, along with a maximum number of steps to run IT_{MAX}. Finally, a value R_{MAX} is specified which represents the numerical range in which to look for the ANN weights and biases, i.e. [−R_{MAX}, +R_{MAX}]. The reason for introducing these physical parameters is not only to define the quantum system to be simulated but also to specify the space of solutions in which to perform the search. In particular, the approach proposed in this document exploits the average position x̅ of a wave function Ψ to find a minimum for the energy/error function U=U(x₁, x₂, . . . , x_{N}). Therefore, the average position x̅ belonging to the physical range [0, Lₓ] is transformed into a variable r which belongs to the range [−R_{MAX}, +R_{MAX}] through the following transformation:

$$r = \frac{2 {R}_{M A X}}{{L}_{x}} ( x - {L}_{x} / 2 )$$

N wave-functions Ψᵢ are prepared in the same initial conditions corresponding to a quantum object which average position is equal to Lₓ/2, step 403. In practice, this is a Gaussian wave function with mean value in x=Lₓ/2 and dispersion σ=Lₓ/5. The boundary conditions for such wave functions are 0 at x=0 and x=Lₓ. This applies during the whole simulation of such quantum objects. It should be noted here that x is not bold because in this case the space is one-dimensional.

Then a main loop 405 over the number of time steps IT_{MAX} is started. In this loop, several operations are performed, 404, among which: a) the computation of the current average position for every wave function of the system, b) the computation of the applied potential for every wave function of the system, and c) the evolution of every wave function by means of the FDTD method. During this time-dependent evolution, the total energy of the system, represented by the quantity U=U(x₁, x₂, . . . , x̅_{N}), can increase or decrease (since the exploration of the solution space is quantum or, in other words, ergodic). Thus, the best solution found, corresponding to the average position (x̅₁, x̅₂, . . . , x̅_{N}) which minimally reduce the potential (or, equivalently, the error function) U, is recorded for future use, step 406. It is important to note that, during this simulation, tunnelling effects will facilitate the search for the best solution (just like it would happen, for instance, in the simulated quantum annealing approach).

At the end of the previous evolution loop, a final pass to improve the accuracy of the solution is performed by means of a standard genetic algorithm refinement where the best solution found by the quantum simulation is improved by using it as the initial conditions of a genetic algorithm, step 407.

A genetic algorithm (GA) is an optimization method inspired by evolution and survival of the fittest, used to generate high-quality solutions to optimization and search problems by relying on biologically inspired operators such as mutation, crossover and selection.

In the last step of the method, a random search of candidate solutions is made and these candidate solutions are then evolved randomly to obtain the next generation of solutions. The standard genetic algorithm is applied using, as input, the energy function that has been reduced. Then, several iterations are executed where descendent are generated from the reduced energy function by randomly changing its values and by selecting the best descendent as a starting point for the next iteration. A person skilled in the art would understand that other implementation of genetic algorithms, or equivalent algorithms could be used and that the skilled person would know how to make this refinement.

While the final step of using standard genetic algorithm refinement does not introduce any quantum effect, it effectively helps to improve the accuracy of the solution found by means of quantum simulations (which precision can be affected by the spatial discretization introduced in the FDTD method).

The final best solution is then utilized to set the weights and biases of the given ANN and to use the ANN to perform inferences.

Two validation tests have been performed to clearly show that the proposed method not only works but also is able to provide solutions which are quantitively and qualitatively different when compared to the solutions obtained with traditional ANN training. These numerical experiments provide clear indications that this method can be utilized in real life scenarios to obtain meaningful and relevant quantum states, i.e., the training of ANNs, by means of digital technology only. The two tests suggested hereinbelow are based on the problem of fitting a curve by means of a given ANN, which is an archetypal problem in ML. The curves to be fitted are represented by the quadratic and square root functions. For every function, three points (xⁱ,yⁱ), for i=1, 2, 3, are provided (in other words, these three points represent the dataset of the problem), in more details for the quadratic function one has:

| x | Y |
|---|---|
| 0.15 | (0.15)² |
| 0.60 | (0.60)² |
| 0.80 | (0.80)² |

while for the square root function, one has:

| X | y |
|---|---|
| 0.15 | (0.15)^{1/2} |
| 0.60 | (0.60)^{1/2} |
| 0.80 | (0.80)^{1/2} |

The ANN utilized to fit the data, in both tests, consists in a network with 6 neurons, 5 as input and 1 as the output with the input neurons being all connected directly to the output neuron. The activation function for the input neurons is hyperbolic tangent while the output activation function is simply the identity function (i.e., f(x)=x). The hyper-parameters for the simulation of the quantum system are Lₓ=10 nm (total length of the physical one-dimensional domain), NX=5000 (number of cells for the spatial discretization), the time step Δt=0.1 femtoseconds, quantum epsilon (QEPS)=1.e−3 (the simulation stops when the energy is below this value), and R_{MAX}=2.75. Finally, the hyperparameters for the final genetic pass are NUM_POPULATION=1e6 (number of elements per generation), NUM_GEN=5000 (total number of generations to be created), and genetic epsilon (GEPS)=1.e-4 (the genetic algorithms stops as soon as the energy is smaller than this value).

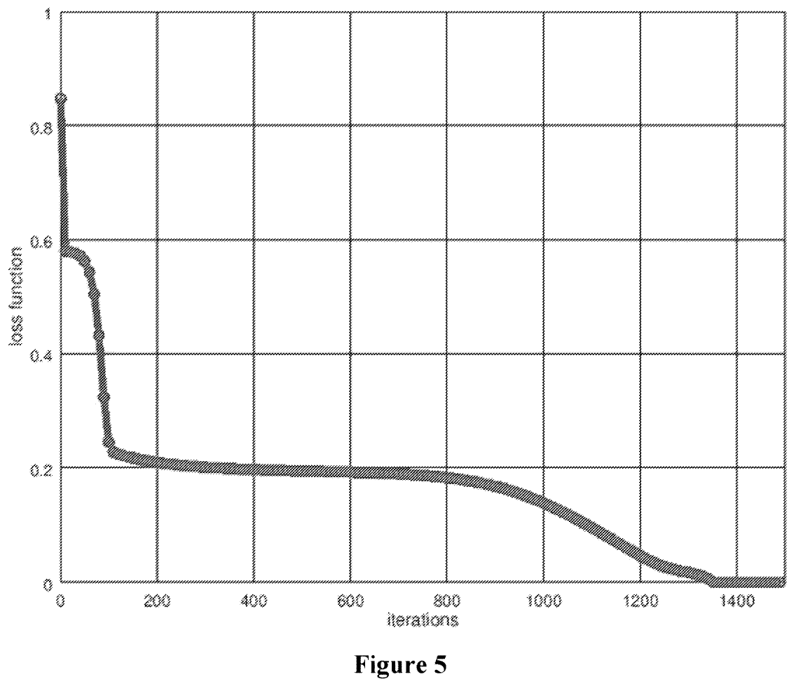

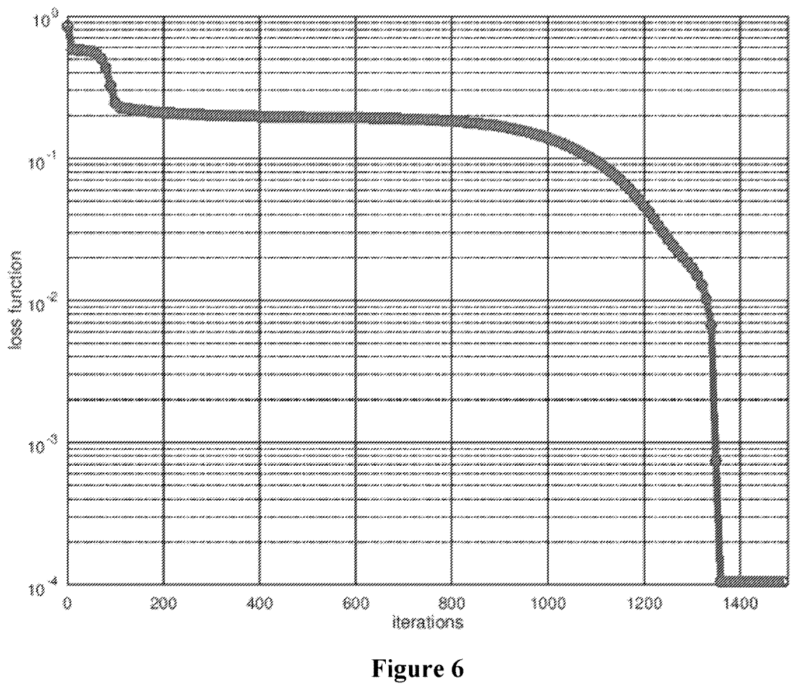

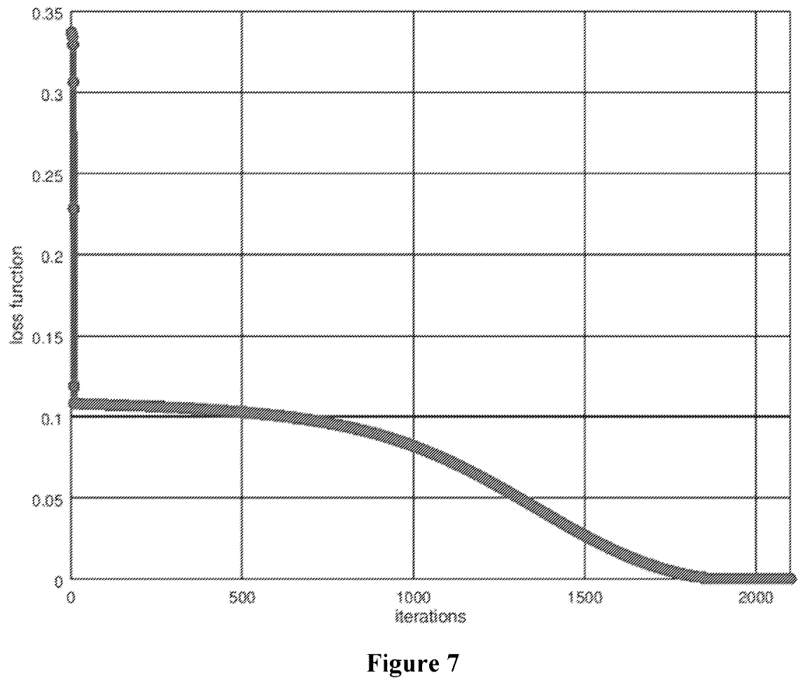

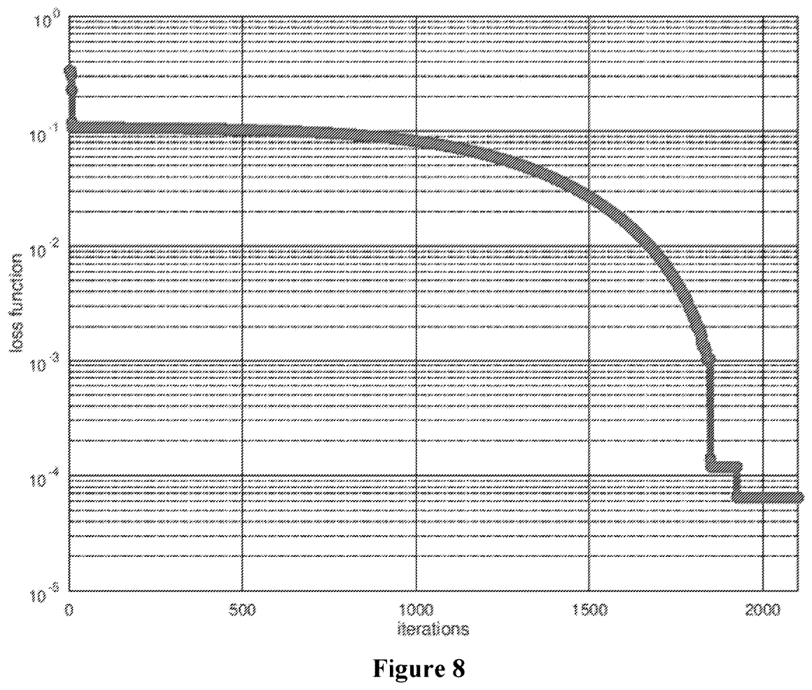

The results for this test are reported in FIGS. 5-11. In more details, FIGS. 5 and 6 show the error function obtained by the gradient descent method training the ANN for this fitting problem on linear (FIG. 5) and logarithmic (FIG. 6) scales respectively. FIGS. 7 and 8 show the same plots but for the method proposed in this document. It is immediately clear that, although they solve the very same problem, the two methods behave very differently during the learning process, thus bringing the ANN to different learning paths. This difference consists in the way the space of solutions is explored, which will be through different paths, although one cannot predict what differences those paths will have.

This is an important point to note since it clearly shows that these two methods provide qualitatively and quantitatively different solutions to the problem. In particular, it seems that the method taught herein reaches lower energies faster than the gradient descent technique. The figures have different scales, which is quite common in Physics. Here, the different scales are due to the fact that the gradient descent and the method presented here compute very different quantities during their iterative computations. For instance, the gradient descent makes computation for a set of iterations while the method described herein computes during a set of time steps. Thus, these two scales cannot be directly compared.

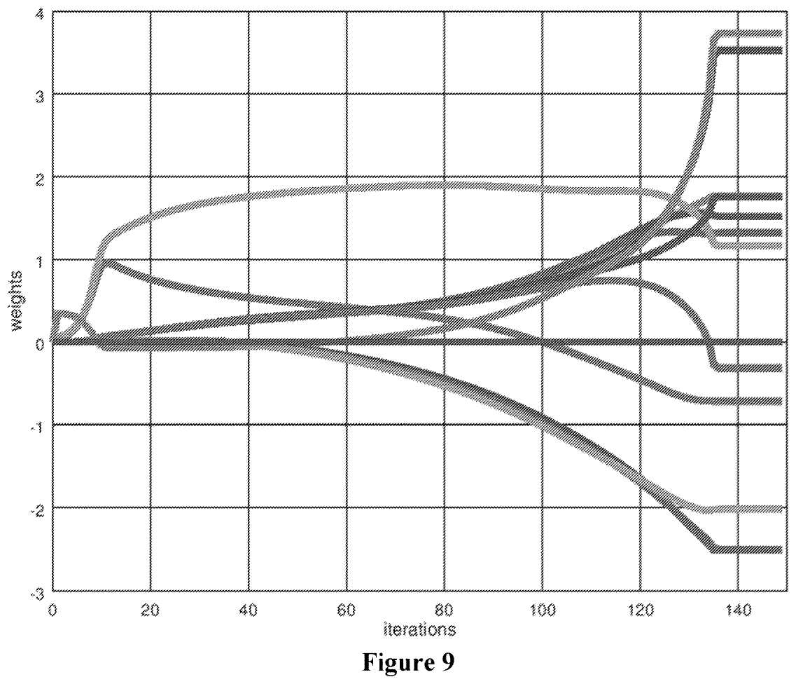

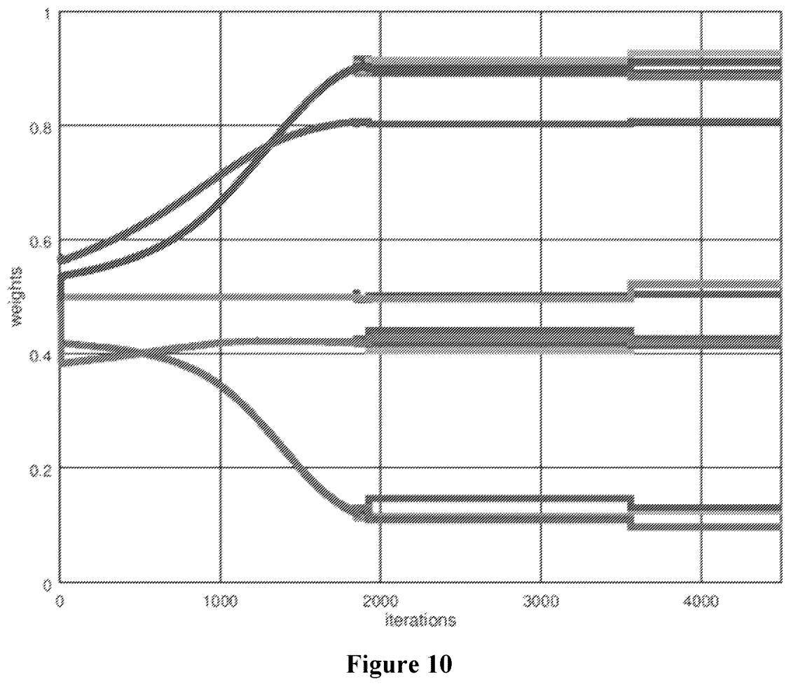

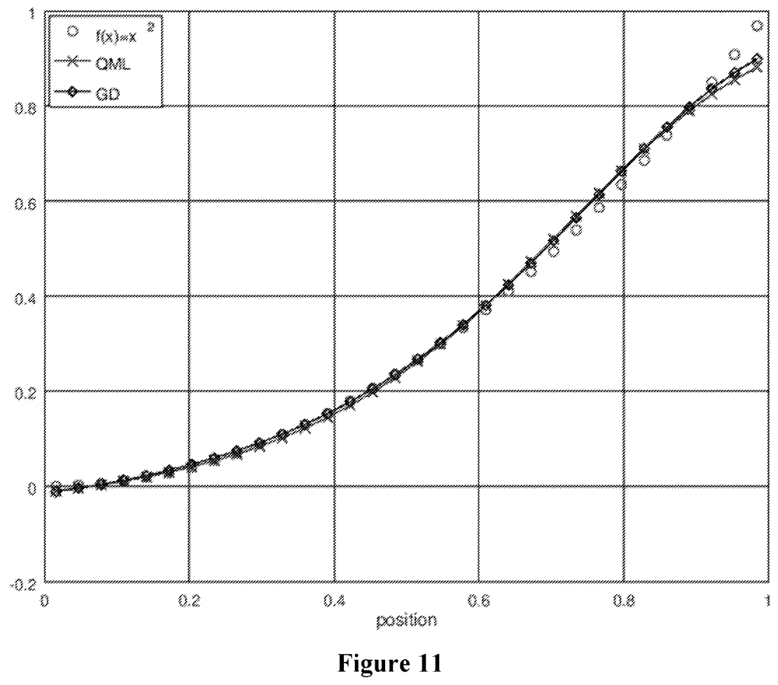

FIGS. 9 and 10 represent the various values for the hyper-parameters to be optimized in function of the iteration number of the learning process. FIG. 9 shows the values of the hyper-parameters of the network in function of the iteration number (arbitrary units) for the gradient descent method, while FIG. 10 shows the same for the method disclosed herein. From these figures, it is even clearer that the two methods go on very different paths during the learning phase. In fact, the curves obtained with these two methods are decidedly different both quantitatively and qualitatively. In the gradient descent case, FIG. 9, the curves smoothly converge towards the final solution (i.e., a local minimum). In the case of the quantum inspired approach, FIG. 10, the curves rapidly reach a final solution and, eventually, that solution can evolve further because of quantum tunnelling effects taking place during the simulation of the quantum system (represented by the jumps in the plot). Moreover, the solutions towards which the two methods converge are different, thus providing neural networks with different quality/behavior. It is expected that the quantum inspired solution provides advantages over classically found solutions. Finally, FIG. 11 shows the curve to be fitted along with the fitting curves provided by the two learning methods.

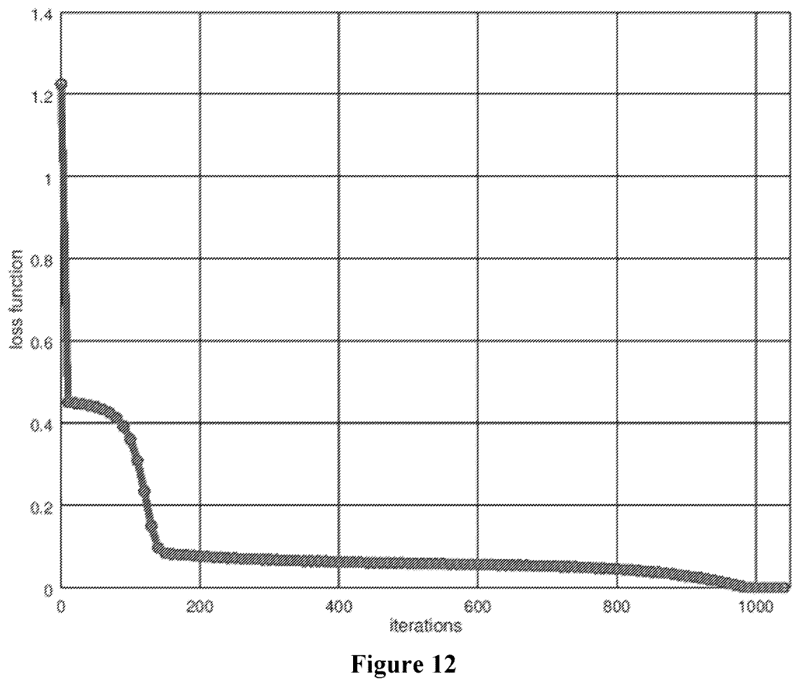

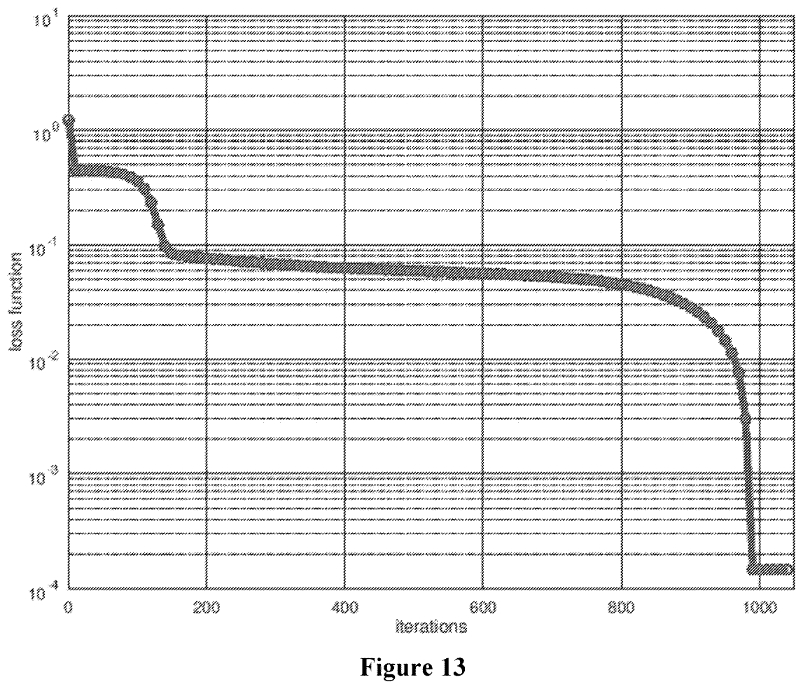

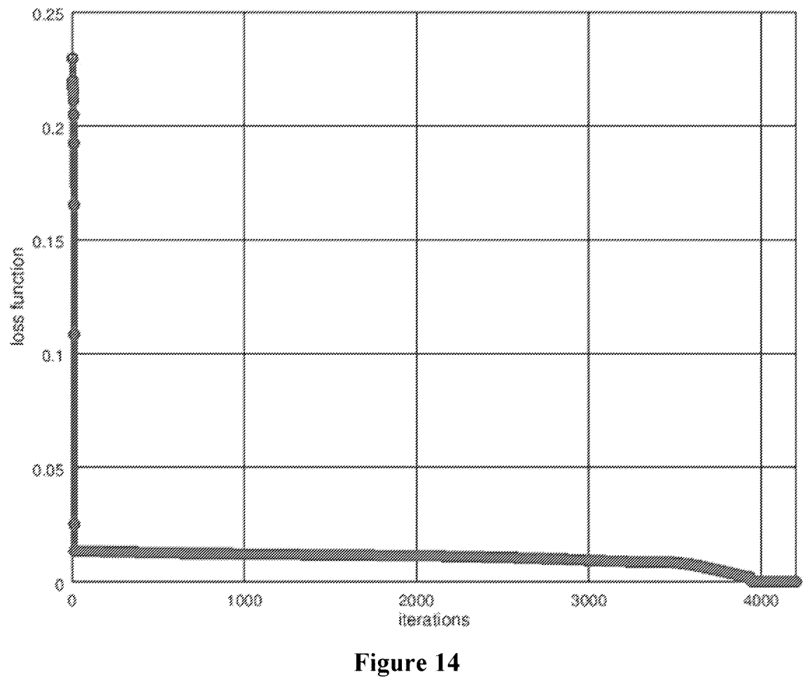

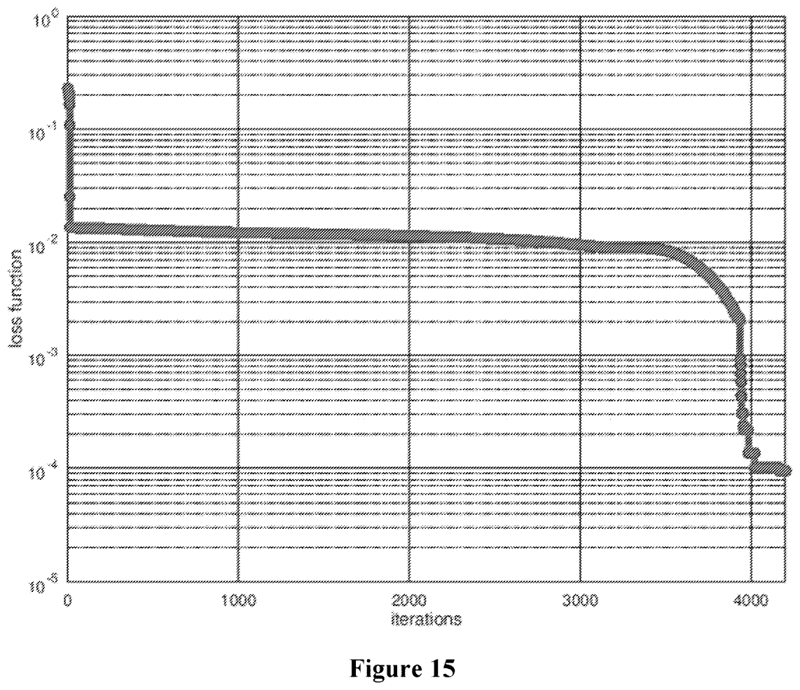

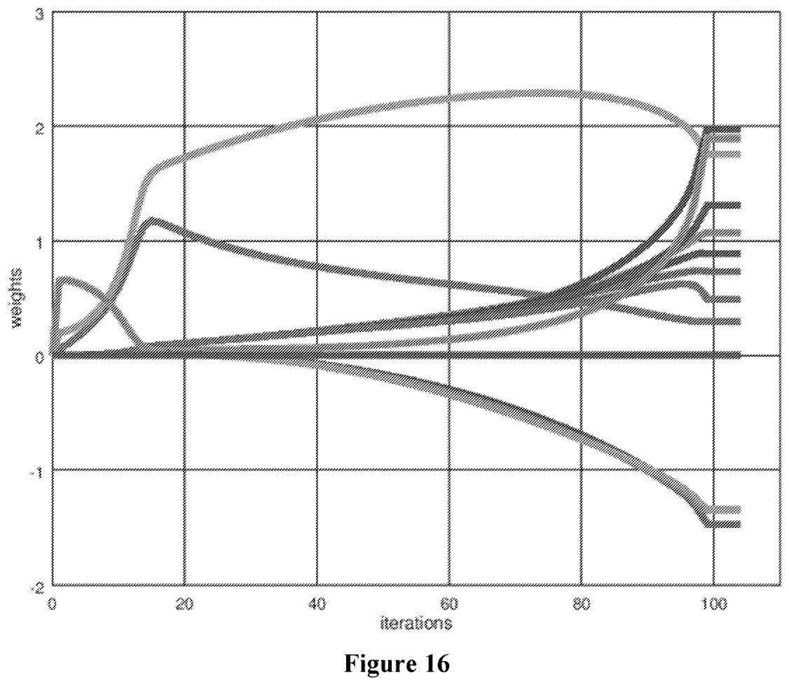

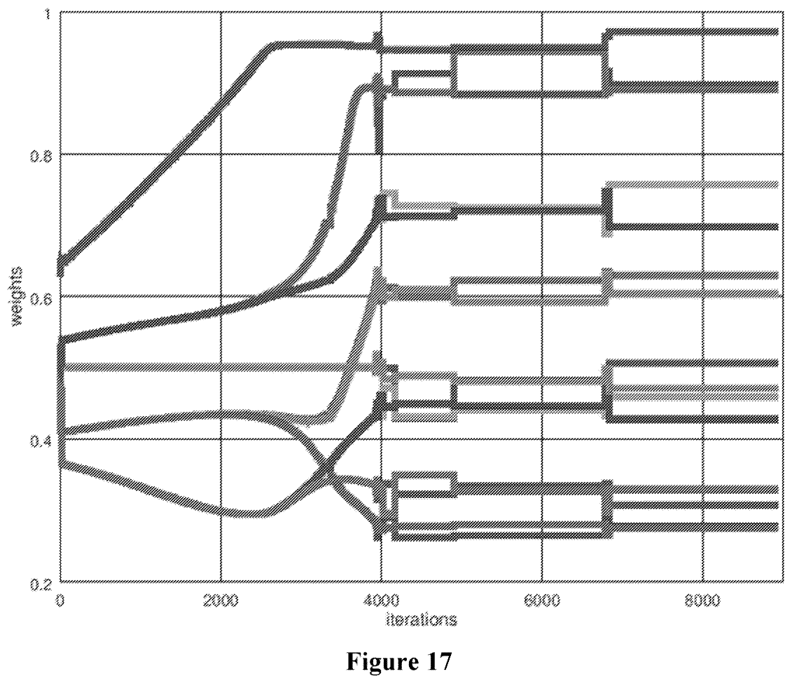

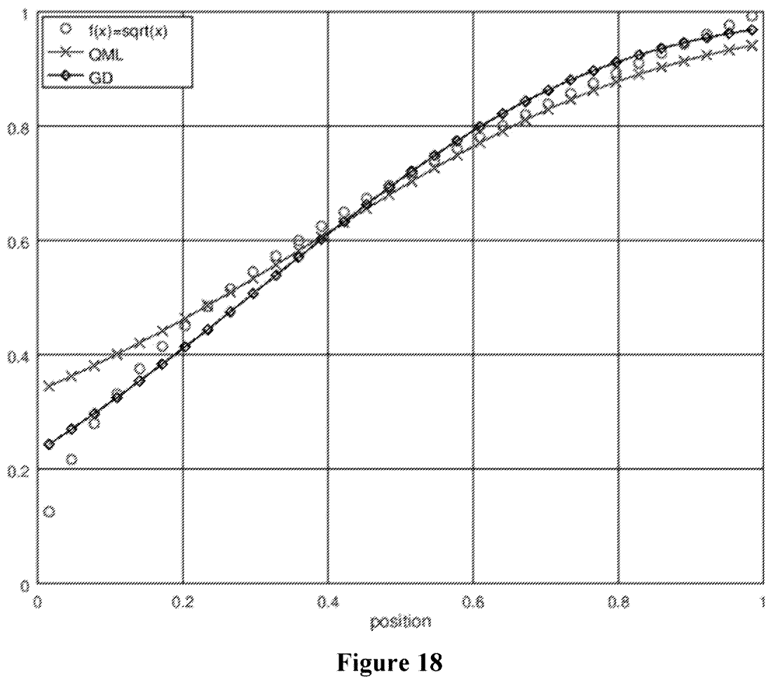

Let's now look at the results for the case of a square root function to be fitted. These results are reported in FIGS. 12 to 18. In details, FIGS. 12 and 13 show the loss/error/cost function obtained by the gradient descent method in both linear and algorithmic scales. FIGS. 14 and 15 shows the same thing but for the quantum inspired method. As it can be seen, the same phenomenon observable in the case of quadratic function fitting is present here. In fact, it is clearly shown that the two methods take very different paths during the learning phase and, in particular, the quantum inspired method seems to reach lower errors at a faster rate. FIGS. 16 and 17 are similar to FIGS. 9 and 10 but for the square root function case. Clearly, the proposed method reaches plateaus more quickly than the gradient descent, moreover the quantum tunnelling jumps are even more visible in this case. Finally, FIG. 18 shows the curve to be fitted along with the solutions provided by the methods.

As a person skilled in the art would acknowledge, the quantum inspired approach proposed herein can certainly be optimized in many different ways. One should note that what is presented herein is a proof of concept. Therefore, one should see the specific implementation presented here not as a limitation of the method itself but, rather, as one possible implementation among others (which is probably one of the simplest ones, devised to focus on the main tenets of the method and not on specific-and most likely irrelevant-details).

As such, possible improvements/alternatives to what has been proposed includes:
the introduction of local density approximation (LDA)-type exchange-correlation terms to increase the level of realism,
the introduction of more realistic activation functions based on biological neuronal measurements, and
the introduction of adaptive mesh refinement on the FDTD method.

Once again, the choices made in this disclosure are not limitations of the proposed method, they are selected only for the purpose of simplifying the discussion.

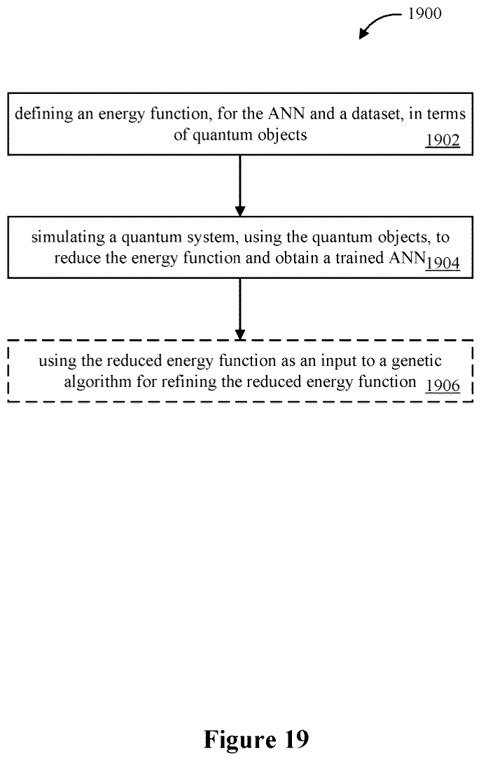

Referring to FIG. 19, there is provided a computer implemented method 1900 for training an artificial neural network (ANN). The method comprises defining, step 1902, an energy function, for the ANN and a dataset, in terms of quantum objects. This means defining the energy function for the ANN and for a particular dataset to be used with this ANN, in terms of quantum objects. The method comprises simulating, 1904 a quantum system, using the quantum objects, to reduce the energy function and obtain a trained ANN.

The energy function may depend on a topology of the ANN and on the dataset, and may be adapted for simulating the quantum system from an error function:

$$E = E ( y ( x ; w ) ; ( {x}^{i} , {y}^{i} ) ) ,$$

where y=y(x; w) represents the ANN as a function and where the dataset is represented by (xⁱ; yⁱ), for i=1, . . . , N.

The energy function may be adapted by transforming the energy function into an exchange-correlation potential suitable for density functional theory (DFT) simulations. The transforming may be obtained by using an average position of the quantum objects constituting the quantum system.

The quantum objects may comprise one object for each of a plurality of hyper-parameters to be trained. The plurality of hyper-parameters to be trained may include one hyper-parameter for each of a plurality of weight and bias of the ANN. The quantum objects may comprise one quantum object for each of: a number of layers of the ANN, a number of neurons per layer, connections between the neurons, a discriminant and at least one activation function for the neurons. The quantum objects may comprise one object for each of a plurality of variables of the quantum system, including: a length of a spatial domain Lx, the spatial domain defining a finite length in which all the quantum objects are confined, a number of spatial cells NX splitting the finite length in portions, a time step Δt to be used for the simulation, a maximum number of steps IT_{MAX} defined as a maximum number of iterations to perform during the simulating of the quantum system, and a maximum numerical range [−R_{MAX}, +R_{MAX}] defining a solution space for each quantum object. NX and Δt may be determined according to available computational resources. For example, NX may be in the hundreds if the method is executed in a single computer, or it may be in the thousands or more, if the method is executed using a cluster of computer or within a cloud implementation.

The energy function may be expressed as:

$$U ( {x}_{i} ) = U ( {\overline{x}}_{1} , {\overline{x}}_{2} , {\overline{x}}_{i - 1} , {x}_{i} , {\overline{x}}_{i + 1} , … , {\overline{x}}_{N} )$$

where xᵢ is an actual position of an i-th body according to a corresponding wave-function and each symbol x̅ᵢ, for i=1, . . . , N represents an average position of the i-th body, which can be expressed as:

$${\overline{x}}_{i} = {\int }_{0}^{{L}_{x}} x {\vert {Ψ}_{i} ( x ) \vert}^{2} d x$$

where Lₓ is a length of a one-dimensional spatial domain and Ψᵢ is the i-th wave-function.

The quantum objects may be described as a set of N single body Schrödinger equations defined as:

$$\begin{matrix}i ℏ \frac{\partial {Ψ}_{1}}{\partial t} = ( - \frac{{ℏ}^{2}}{2 m} \frac{{\partial }^{2}}{\partial {x}_{1}^{2}} + U ( {x}_{1} , {x}_{2} , … , {x}_{N} ) ) {Ψ}_{1} , \\ i ℏ \frac{\partial {Ψ}_{2}}{\partial t} = ( - \frac{{ℏ}^{2}}{2 m} \frac{{\partial }^{2}}{\partial {x}_{2}^{2}} + U ( {x}_{1} , {x}_{2} , … , {x}_{N} ) ) {Ψ}_{2} , \\ … \\ i ℏ \frac{\partial {Ψ}_{N}}{\partial t} = ( - \frac{{ℏ}^{2}}{2 m} \frac{{\partial }^{2}}{\partial {x}_{N}^{2}} + U ( {x}_{1} , {x}_{2} , … , {x}_{N} ) ) {Ψ}_{N}\end{matrix}$$

where ℏ is the reduced Planck constant and m is the mass of an electron.

Simulating the quantum system may comprise iteratively solving the set of N single body Schrödinger equations until the energy function is minimized, under a quantum epsilon (QEPS) threshold, or until a maximum number of steps IT_{MAX} is reached.

Iteratively solving the set of N single body Schrödinger equations may comprise computing a current average position for every wave function of the system; computing an applied potential for every wave function of the system; and evolving every wave function by means of the finite-difference time domain (FDTD) method.

The weights and biases, r, of the trained ANN may be extracted from each corresponding average positions x̅ of the reduced energy function using the equation:

$$r = \frac{2 {R}_{M A X}}{{L}_{x}} ( x - \frac{{L}_{x}}{2} )$$

where [−R_{MAX}, +R_{MAX}] define a maximum numerical range of the solution space and Lx defines a length of a spatial domain.

The method may further comprise using, step 1906, the reduced energy function as an input to a genetic algorithm for refining the reduced energy function. The refining may refine average positions x̅ of the energy function.

The genetic algorithm may iterate and use for a next iteration the reduced energy function, or if no reduced energy function could be obtained in an iteration, a previous reduced energy function, until the reduced energy function is minimized under a genetic epsilon (GEPS) threshold or until a maximum number of iterations is reached.

The method may further comprise any of the steps described herein.

It should be noted that methods and steps described herein are, generally, computer implemented methods and steps. The term computer may be interpreted as having different meanings, such as explained next, for example.

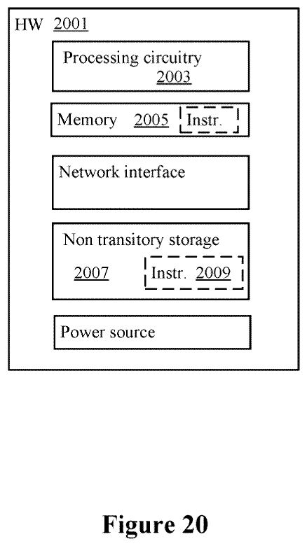

Referring to FIG. 20, there is provided an apparatus, computer, server or device (HW) 2001, in which functions and steps described herein, for training an ANN, can be implemented.

The apparatus 2001 may be a server, network node, radio base station, or other computing device which may be part of a cloud computing system, edge computing system, or which may be a standalone device. The apparatus is operative to execute selected steps, or all of the steps, of the method described herein for training an ANN. It is also operative to store the ANN, to use the ANN and to send/receive the ANN. In some embodiments, the apparatus could be part of a system comprising a plurality of apparatuses, in which it could be advantageous to execute the method in a distributed fashion.

The apparatus 2001 comprises processing circuitry 2003 and memory 2005. The memory 2005 can contain instructions executable by the processing circuitry 2003 whereby functions and steps described herein may be executed to provide any of the relevant features and benefits disclosed herein.

The apparatus 2001 may also include non-transitory, persistent, machine-readable storage media 2007 having stored therein software and/or instruction 2009 executable by the processing circuitry 2003 to execute functions and steps described herein. The apparatus may also include network interface(s) and a power source.

The instructions 2009 may include a computer program for configuring the processing circuitry 2003. The computer program may be stored in a physical memory local to the device, which can be removable, or it could alternatively, or in part, be stored in the cloud. The computer program may also be embodied in a carrier such as an electronic signal, optical signal, radio signal, or computer readable storage medium.

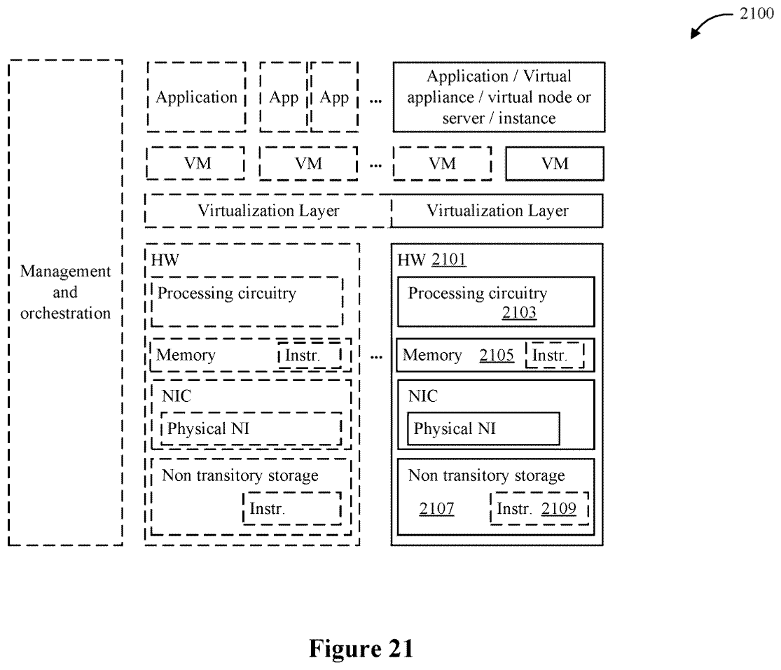

Referring to FIG. 21, there is provided a virtualization environment 2100 in which functions and steps described herein, for training an ANN, can be implemented.

The virtualization environment 2100 (which may go beyond what is illustrated in FIG. 21), may comprise systems, networks, servers, nodes, computers, devices, etc., that are in communication with each other either through wire or wirelessly, e.g., through a network interface component (NIC) comprising physical network interface(s) (NI). Some or all of the functions and steps described herein may be implemented as one or more virtual components (e.g., via one or more applications, components, functions, virtual machines, containers, etc.) executing on one or more physical apparatus in one or more networks, systems, environment, etc.

A virtualization environment provides hardware 2101 comprising processing circuitry 2103 and memory 2105. The memory 2105 can contain instructions executable by the processing circuitry 2103 whereby functions and steps described herein may be executed to provide any of the relevant features and benefits disclosed herein.

The hardware 2101 may also include non-transitory, persistent, machine-readable storage media 2107 having stored therein software and/or instruction 2109 executable by the processing circuitry 2103 to execute functions and steps described herein.

The instructions 2109 may include a computer program for configuring the processing circuitry 2103. The computer program may be stored in a removable memory, such as a portable compact disc, portable digital video disc, or other removable media. The computer program may also be embodied in a carrier such as an electronic signal, optical signal, radio signal, or computer readable storage medium.

Referring to FIGS. 20 and 21, there is provided a system 2001, 2100, 2101 for training an artificial neural network (ANN), which may consist of a single computing device, a cluster of computing devices or a cloud of computing device. The system comprises processing circuitry 2003, 2103 and a memory 2005, 2105, the memory containing instructions executable by the processing circuitry whereby the system is operative to define an energy function, for the ANN and a dataset, in terms of quantum objects and simulate a quantum system, using the quantum objects, to reduce the energy function and obtain a trained ANN.

The energy function may depend on a topology of the ANN and on the dataset, and may be adapted for simulating the quantum system from an error function:

$$E = E ( y ( x ; w ) , ( {x}^{i} , {y}^{i} ) ) ,$$

where y=y(x; w) represents the ANN as a function and where the dataset is represented by (xⁱ; yⁱ), for i=1, . . . , N.

The energy function may be adapted by transforming the energy function into an exchange-correlation potential suitable for density functional theory (DFT) simulations. The transforming may be obtained by using an average position of the quantum objects constituting the quantum system.

The quantum objects may comprise one object for each of a plurality of hyper-parameters to be trained. The plurality of hyper-parameters to be trained may include one hyper-parameter for each of a plurality of weight and bias of the ANN. The quantum objects may comprise one quantum object for each of: a number of layers of the ANN, a number of neurons per layer, connections between the neurons, a discriminant and at least one activation function for the neurons. The quantum objects may comprise one object for each of a plurality of variables of the quantum system, including: a length of a spatial domain Lx, the spatial domain defining a finite length in which all the quantum objects are confined, a number of spatial cells NX splitting the finite length in portions, a time step Δt to be used for the simulation, a maximum number of steps IT_{MAX} defined as a maximum number of iterations to perform during the simulating of the quantum system, and a maximum numerical range [−R_{MAX}, +R_{MAX}] defining a solution space for each quantum object. NX and Δt may be determined according to available computational resources.

The energy function may be expressed as:

$$U ( {x}_{i} ) = U ( {\overline{x}}_{1} , {\overline{x}}_{2} , … , {\overline{x}}_{i - 1} , {x}_{i} , {\overline{x}}_{i + 1} , … , {\overline{x}}_{N} )$$

where xᵢ is an actual position of an i-th body according to a corresponding wave-function and each symbol x̅ᵢ, for i=1, . . . , N represents an average position of the i-th body, which can be expressed as:

$${\overline{x}}_{i} = {\int }_{0}^{{L}_{x}} x {\vert {Ψ}_{i} ( x ) \vert}^{2} d x$$

where Lₓ is a length of a one-dimensional spatial domain and Ψᵢ is the i-th wave-function.

The quantum objects may be described as a set of N single body Schrödinger equations defined as:

$$i ℏ \frac{\partial {Ψ}_{1}}{\partial t} = ( - \frac{{ℏ}^{2}}{2 m} \frac{{\partial }^{2}}{\partial {x}_{1}^{2}} + U ( {x}_{1} ) ) {Ψ}_{1} ,$$

$$i ℏ \frac{\partial {Ψ}_{2}}{\partial t} = ( - \frac{{ℏ}^{2}}{2 m} \frac{{\partial }^{2}}{\partial {x}_{2}^{2}} + U ( {x}_{2} ) ) {Ψ}_{2} ,$$

$$i ℏ \frac{\partial {Ψ}_{N}}{\partial t} = ( - \frac{{ℏ}^{2}}{2 m} \frac{{\partial }^{2}}{\partial {x}_{N}^{2}} + U ( {x}_{N} ) ) {Ψ}_{N}$$

where ℏ is the reduced Planck constant and m is the mass of an electron.

The system may be further operative to simulate the quantum system by iteratively solving the set of N single body Schrödinger equations until the energy function is minimized, under a quantum epsilon (QEPS) threshold, or until a maximum number of steps IT_{MAX} is reached.

The system may be further operative to iteratively solving the set of N single body Schrödinger equations by computing a current average position for every wave function of the system; computing an applied potential for every wave function of the system; and evolving every wave function by means of the finite-difference time domain (FDTD) method.

The weights and biases, r, of the trained ANN may be extracted from each corresponding average positions x̅ of the reduced energy function using the equation:

$$r = \frac{2 {R}_{MAX}}{{L}_{x}} ( x - {L}_{x} / 2 )$$

where [−R_{MAX}, +R_{MAX}] define a maximum numerical range of the solution space and Lx defines a length of a spatial domain.

The system may be further operative to use the reduced energy function as an input to a genetic algorithm for refining the reduced energy function. The genetic algorithm may iterate and use for a next iteration the reduced energy function, or if no reduced energy function could be obtained in an iteration, a previous reduced energy function, until the reduced energy function is minimized under a genetic epsilon (GEPS) threshold or until a maximum number of iterations is reached.

The system may further be operative to execute any of the steps described herein.

Still referring to FIGS. 20 and 21, there is provided a non-transitory computer readable media 2007, 2107 having stored thereon instructions 2009, 2109 for training an artificial neural network (ANN). The instructions comprise defining an energy function, for the ANN and a dataset, in terms of quantum objects and simulating a quantum system, using the quantum objects, to reduce the energy function and obtain a trained ANN.

The non-transitory computer readable media may further comprise instructions for executing any of the steps described herein.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A computer implemented method for training an artificial neural network (ANN), comprising:
defining an energy function, for the ANN and a dataset, in terms of quantum objects; and
simulating a quantum system, using the quantum objects, to reduce the energy function and obtain a trained ANN.

2. The method of claim 1, wherein the energy function depends on a topology of the ANN and on the dataset, and is adapted for simulating the quantum system from an error function:
$$E = E ( y ( x ; w ) , ( {x}^{i} , {y}^{i} ) ) ,$$
where y=y(x; w) represents the ANN as a function and where the dataset is represented by (xⁱ; yⁱ), for i=1, . . . , N.

3. The method of claim 2, wherein the energy function is adapted by transforming the energy function into an exchange-correlation potential suitable for density functional theory (DFT) simulations and wherein the transforming is obtained by using an average position of the quantum objects constituting the quantum system.

4. (canceled)

5. The method of claim 1, wherein the quantum objects comprise one object for each of a plurality of hyper-parameters to be trained and wherein the plurality of hyper-parameters to be trained include one hyper-parameter for each of a plurality of weight and bias of the ANN.

6. (canceled)

7. The method of claim 1, wherein the quantum objects comprise one quantum object for each of: a number of layers of the ANN, a number of neurons per layer, connections between the neurons, a discriminant and at least one activation function for the neurons.

8. The method of claim 1, wherein the quantum objects comprise one object for each of a plurality of variables of the quantum system, including: a length of a spatial domain Lx, the spatial domain defining a finite length in which all the quantum objects are confined, a number of spatial cells NX splitting the finite length in portions, a time step Δt to be used for the simulation, a maximum number of steps IT_{MAX} defined as a maximum number of iterations to perform during the simulating of the quantum system, and a maximum numerical range [−R_{MAX}, +R_{MAX}] defining a solution space for each quantum object.

9. (canceled)

10. The method of claim 1, wherein the energy function is expressed as:
$$U ( {x}_{i} ) = U ( {\overline{x}}_{1} , {\overline{x}}_{2} , … , {\overline{x}}_{i - 1} , {x}_{i} , {\overline{x}}_{i + 1} , … , {\overline{x}}_{N} )$$
where xᵢ is an actual position of an i-th body according to a corresponding wave-function and each symbol x̅ᵢ, for i=1, . . . , N represents an average position of the i-th body, which can be expressed as:
$${\overline{x}}_{i} = {\int }_{0}^{{L}_{x}} x {\vert {Ψ}_{i} ( x ) \vert}^{2} d x$$
where Lₓ is a length of a one-dimensional spatial domain and Ψᵢ is the i-th wave-function.

11. The method of claim 1, wherein the quantum objects are described as a set of N single body Schrödinger equations defined as:
$$i ℏ \frac{\partial {Ψ}_{1}}{\partial t} = ( - \frac{{ℏ}^{2}}{2 m} \frac{{\partial }^{2}}{\partial {x}_{1}^{2}} + U ( {x}_{1} ) ) {Ψ}_{1} ,$$
$$i ℏ \frac{\partial {Ψ}_{2}}{\partial t} = ( - \frac{{ℏ}^{2}}{2 m} \frac{{\partial }^{2}}{\partial {x}_{2}^{2}} + U ( {x}_{2} ) ) {Ψ}_{2} ,$$
$$i ℏ \frac{\partial {Ψ}_{N}}{\partial t} = ( - \frac{{ℏ}^{2}}{2 m} \frac{{\partial }^{2}}{\partial {x}_{N}^{2}} + U ( {x}_{N} ) ) {Ψ}_{N}$$
where ℏ is the reduced Planck constant and m is the mass of an electron.

12. The method of claim 11, wherein simulating the quantum system comprises iteratively solving the set of N single body Schrödinger equations until the energy function is minimized, under a quantum epsilon (QEPS) threshold, or until a maximum number of steps IT_{MAX} is reached.

13. The method of claim 12, wherein iteratively solving the set of N single body Schrödinger equations comprises:
computing a current average position for every wave function of the system;
computing an applied potential for every wave function of the system; and
evolving every wave function by means of the finite-difference time domain (FDTD) method.

14. The method of claim 12, wherein weights and biases, r, of the trained ANN are extracted from each corresponding average positions x̅ of the reduced energy function using the equation:
$$r = \frac{2 {R}_{MAX}}{{L}_{x}} ( x - {L}_{x} / 2 )$$
where [−R_{MAX}, +R_{MAX}] define a maximum numerical range of the solution space and Lx defines a length of a spatial domain.

15. The method of claim 1, further comprising using the reduced energy function as an input to a genetic algorithm for refining the reduced energy function, wherein the genetic algorithm iterates and uses for a next iteration the reduced energy function, or if no reduced energy function could be obtained in an iteration, a previous reduced energy function, until the reduced energy function is minimized under a genetic epsilon (GEPS) threshold or until a maximum number of iterations is reached.

16. (canceled)

17. An apparatus for training an artificial neural network (ANN) comprising processing circuitry and a memory, the memory containing instructions executable by the processing circuitry whereby the apparatus is operative to:
define an energy function, for the ANN and a dataset, in terms of quantum objects; and
simulate a quantum system, using the quantum objects, to reduce the energy function and obtain a trained ANN.

18. The apparatus of claim 17, wherein the energy function depends on a topology of the ANN and on the dataset, and is adapted for simulating the quantum system from an error function:
$$E = E ( y ( x ; w ) , ( {x}^{i} , {y}^{i} ) ) ,$$
where y=y(x; w) represents the ANN as a function and where the dataset is represented by (xⁱ; yⁱ), for i=1, . . . , N.

19. The apparatus of claim 18, wherein the energy function is adapted by transforming the energy function into an exchange-correlation potential suitable for density functional theory (DFT) simulations and wherein the transforming is obtained by using an average position of the quantum objects constituting the quantum system.

20. (canceled)

21. The apparatus of claim 17, wherein the quantum objects comprise one object for each of a plurality of hyper-parameters to be trained and wherein the plurality of hyper-parameters to be trained include one hyper-parameter for each of a plurality of weight and bias of the ANN.

22. (canceled)

23. The apparatus of claim 17, wherein the quantum objects comprise one quantum object for each of: a number of layers of the ANN, a number of neurons per layer, connections between the neurons, a discriminant and at least one activation function for the neurons.

24. The apparatus of claim 17, wherein the quantum objects comprise one object for each of a plurality of variables of the quantum system, including: a length of a spatial domain Lx, the spatial domain defining a finite length in which all the quantum objects are confined, a number of spatial cells NX splitting the finite length in portions, a time step Δt to be used for the simulation, a maximum number of steps IT_{MAX} defined as a maximum number of iterations to perform during the simulating of the quantum system, and a maximum numerical range [−R_{MAX}, +R_{MAX}] defining a solution space for each quantum object.

25. (canceled)

26. The apparatus of claim 17, wherein the energy function is expressed as:
$$U ( {x}_{i} ) = U ( {\overline{x}}_{1} , {\overline{x}}_{2} , … , {\overline{x}}_{i - 1} , {x}_{i} , {\overline{x}}_{i + 1} , … , {\overline{x}}_{N} )$$
where xᵢ is an actual position of an i-th body according to a corresponding wave-function and each symbol x̅ᵢ, for i=1, . . . , N represents an average position of the i-th body, which can be expressed as:
$${\overline{x}}_{i} = {\int }_{0}^{{L}_{x}} x {\vert {Ψ}_{i} ( x ) \vert}^{2} d x$$
where Lₓ is a length of a one-dimensional spatial domain and Ψᵢ is the i-th wave-function.

27. The apparatus of claim 17, wherein the quantum objects are described as a set of N single body Schrödinger equations defined as:
$$i ℏ \frac{\partial {Ψ}_{1}}{\partial t} = ( - \frac{{ℏ}^{2}}{2 m} \frac{{\partial }^{2}}{\partial {x}_{1}^{2}} + U ( {x}_{1} ) ) {Ψ}_{1} ,$$
$$i ℏ \frac{\partial {Ψ}_{2}}{\partial t} = ( - \frac{{ℏ}^{2}}{2 m} \frac{{\partial }^{2}}{\partial {x}_{2}^{2}} + U ( {x}_{2} ) ) {Ψ}_{2} ,$$
$$i ℏ \frac{\partial {Ψ}_{N}}{\partial t} = ( - \frac{{ℏ}^{2}}{2 m} \frac{{\partial }^{2}}{\partial {x}_{N}^{2}} + U ( {x}_{N} ) ) {Ψ}_{N}$$
where ℏ is the reduced Planck constant and m is the mass of an electron.

28. The apparatus of claim 27, further operative to simulate the quantum system by iteratively solving the set of N single body Schrödinger equations until the energy function is minimized, under a quantum epsilon (QEPS) threshold, or until a maximum number of steps IT_{MAX} is reached.

29. The apparatus of claim 28, further operative to iteratively solving the set of N single body Schrödinger equations by:
computing a current average position for every wave function of the system;
computing an applied potential for every wave function of the system; and
evolving every wave function by means of the finite-difference time domain (FDTD) method.

30. The apparatus of claim 28, wherein weights and biases, r, of the trained ANN are extracted from each corresponding average positions x̅ of the reduced energy function using the equation:
$$r = \frac{2 {R}_{MAX}}{{L}_{x}} ( x - {L}_{x} / 2 )$$
where [−R_{MAX}, +R_{MAX}] define a maximum numerical range of the solution space and Lx defines a length of a spatial domain.

31. The apparatus of claim 17, further operative to use the reduced energy function as an input to a genetic algorithm for refining the reduced energy function, wherein the genetic algorithm iterates and uses for a next iteration the reduced energy function, or if no reduced energy function could be obtained in an iteration, a previous reduced energy function, until the reduced energy function is minimized under a genetic epsilon (GEPS) threshold or until a maximum number of iterations is reached.

32. (canceled)

33. A non-transitory computer readable media having stored thereon instructions for training an artificial neural network (ANN), the instructions comprising:
defining an energy function, for the ANN and a dataset, in terms of quantum objects; and
simulating a quantum system, using the quantum objects, to reduce the energy function and obtain a trained ANN.

34. (canceled)
